(19) United States
(12) Patent Application Publication
(10) Pub. No.: US 2012/0013809 A1
(43) Pub. Date: Jan. 19, 2012

(54) ELECTRIC APPARATUS

(76) Inventor: Takehiro TOYA, Osaka (JP)

(21) Appl. No.: 13/177,835

(22) Filed: Jul. 7, 2011

(30) Foreign Application Priority Data
Jul. 15, 2010 (JP) 2010-160928

(51) Int. Cl. H04N 5/44

(52) U.S. Cl. 348/734; 348/E05.096

(57) ABSTRACT

Disclosed is an electric apparatus having a remote controller receiver function. The electric apparatus includes a main body operation keypad including a plurality of main body keys, and a control portion for changing functions assigned to the main body keys based on a specific file provided from outside.

This nonprovisional application claims priority under 35 U.S.C. §119(a) on Patent Application No. 2010-160928 filed in Japan on Jul. 15, 2010,the entire contents of which are hereby incorporated by reference.

### BACKGROUND OF THE INVENTION

1. Field of the Invention

The present invention relates to an electric apparatus, especially relates to an electric apparatus having a remote controller receiver function.

2. Description of Related Art

In electric apparatus having remote controller receiver functions, it is a recent trend that the number of keys on the main body operation portion is reduced as much as possible and these keys are gathered onto the remote controller transmitter side, so as to have a smaller operation portion on the apparatus main body in response to the requirement of compact apparatus main body.

A problem would arise when a user loses the remote controller transmitter or the remote controller transmitter gets broken, in which the user cannot execute functions that can be executed only by the operation of the remote controller transmitter.

To solve the problem, a technology was proposed in JP2005-86481A and JP2006-179097A.

JP2005-86481A proposed an audiovisual apparatus including an apparatus main body having a plurality of keys and a remote controller having a plurality of keys. The audiovisual apparatus further includes a first special key placed on the apparatus main body, a second special key placed on the apparatus main body, and a control portion for controlling the operation of a display portion connected to the apparatus main body, as well as the apparatus main body and the remote controller. The control portion displays the names of remote controller keys sequentially on the display portion every time the first special key is pressed and executes the function of the key displayed on the display portion when the second special key is pressed.

An audiovisual apparatus having such a configuration, however, needs to store, in a non-volatile manner, the data necessary to display the names of remote controller keys sequentially on the display portion every time the first special key is pressed for cases in which a user loses the remote controller transmitter or the remote controller transmitter gets broken, which wastes the memory capacity. In an audiovisual apparatus having such a configuration, the order in which the names of remote controller keys is displayed on the display portion is fixed, so it will be inconvenient for a user if he/she has to press the first special key many times to display the name of a frequently used remote controller key.

JP2006-179097A proposed an optical disk device for reproducing or recording/reproducing information from/to an optical disk, having a remote controller having a plurality of keys for operating the device and a main body operation portion having a smaller number of keys than those on the remote controller. The optical disk device further includes a system controller having a counter to count, while one of selected two main body keys on the main body operation portion is kept pressed, the number of pressing the other main body key; a table designating the relationship between counts of pressing and key codes and key names of the remote controller keys; a key defining means that, by extracting from the table a key code corresponding to the count at the time the one main body key is released, defines the function of the one main body key as that of the remote controller key designated by the key code; and a key name display means that extracts from the table and display on the display means a remote controller key name corresponding to the count.

An optical disk device having such a configuration, however, needs to store, in a non-volatile manner, the table necessary for cases in which a user loses the remote controller transmitter or the remote controller transmitter gets broken, which wastes the memory capacity. In an optical disk device having such a configuration, the relationship between the count of pressing and key codes and key names of the remote controller keys is fixed in the table, so it will be inconvenient for a user if a frequently used key of the remote controller is designated to a large count.

### SUMMARY OF THE INVENTION

The objective of the present invention is to provide an electric apparatus having a remote controller receiver function in which functions that can be executed by the operation of the remote controller transmitter can be executed by the operation of the main body operation portion without wasting memory capacity.

To achieving the objective, the present invention provides an electric apparatus having a remote controller receiver function, includes a main body operation keypad including a plurality of main body keys; and a control portion for changing functions assigned to the main body keys based on a specific file provided from outside (first configuration).

With the configuration, functions that can be executed by the operation of remote controller keys can be executed by the operation of main body keys using a specific file provided from outside. Because it uses a specific file provided from outside, it does not waste the memory capacity of the electric apparatus.

The electric apparatus having the first configuration may include an external recording medium interface to removably connect an external recording medium, and the specific file may be provided from the external recording medium. In this case, the control portion preferably changes functions assigned to the main body keys based on the specific file only during a period when an external recording medium recording the specific file is connected to the external recording medium interface.

The electric apparatus having the first configuration may include a network interface to be connected to a network, and the specific file may be provided via the network and the network interface. In this case, the electric apparatus preferably includes a memory portion to temporarily store the specific file, and the control portion preferably changes functions assigned to the main body keys based on the specific file temporarily stored in the memory portion.

The electric apparatus having the first configuration may be an optical disk device, and the specific file may be provided from the optical disk. In this case, the electric apparatus preferably includes a memory portion to temporarily store the specific file, and the control portion preferably changes functions assigned to the main body keys based on the specific file temporarily stored in the memory portion.

### BRIEF DESCRIPTION OF THE DRAWINGS

FIG. 1 shows a schematic configuration of a HDD-incorporated DVD recorder according to a first embodiment of the present invention.

FIG. 2 shows a flowchart indicating an operation when a USB memory is connected to the USB interface of the HDD-incorporated DVD recorder in FIG. 1.

FIG. 3 shows an example of assignment change to main body keys.

FIG. 4 shows another example of assignment change to main body keys.

FIG. 5 shows a schematic configuration of a HDD-incorporated DVD recorder according to a second embodiment of the present invention.

FIG. 6 shows a flowchart indicating an operation when a predetermined main body key is kept pressed on the HDD-incorporated DVD recorder in FIG. 5.

FIG. 7 shows a schematic configuration of a HDD-incorporated DVD recorder according to a third embodiment of the present invention.

FIG. 8 shows a flowchart indicating an operation when a DVD is mounted into the DVD recording/reproducing portion of the HDD-incorporated DVD recorder in FIG. 7.

### DETAILED DESCRIPTION OF PREFERRED EMBODIMENTS

Embodiments of the present invention are now explained with reference to the accompanying drawings. The explanation herein will be made using a HDD (Hard Disk Drive)-incorporated DVD recorder as an example of the electric apparatus according to the present invention.

### First Embodiment of the Present Invention

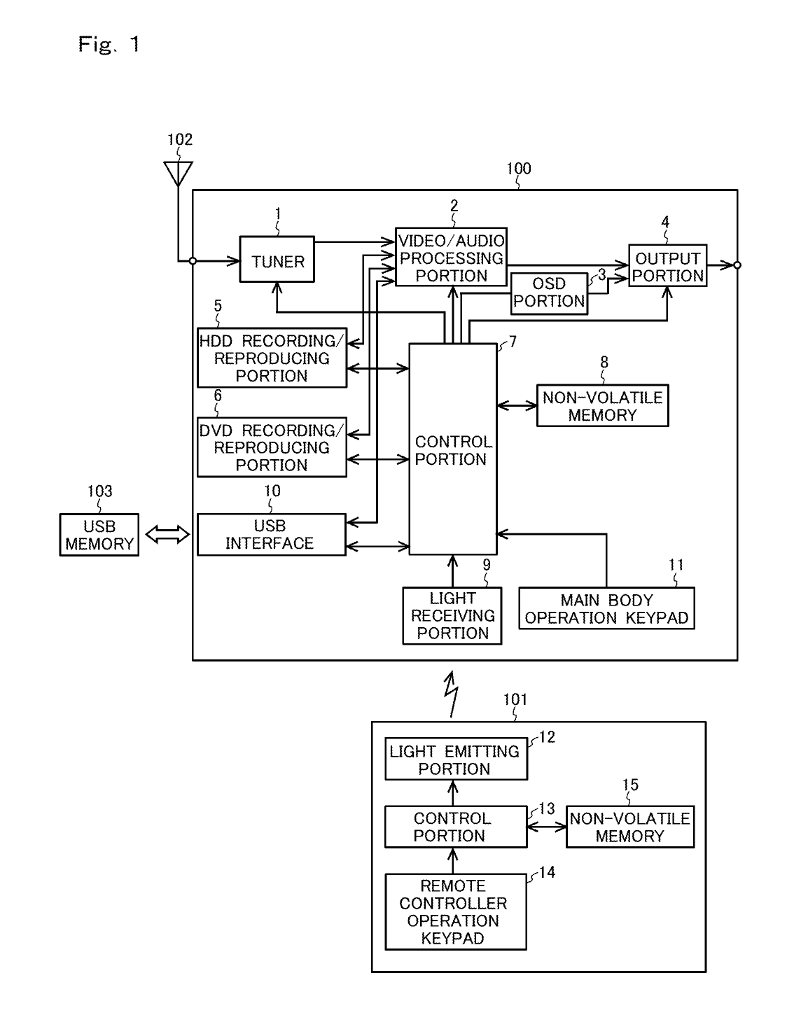

FIG. 1 shows a schematic configuration of a HDD-incorporated DVD recorder according to the first embodiment of the present invention. The HDD-incorporated DVD recorder 100 according to the first embodiment of the present invention in FIG. 1 (referred to as “HDD-incorporated DVD recorder 100,” hereafter) includes a tuner 1, a video/audio processing portion 2, an OSD (On Screen Display) portion 3, an output portion 4, a HDD recording/reproducing portion 5, a DVD recording/reproducing portion 6, a control portion 7, a non-volatile memory 8, a light receiving portion 9, a USB (Universal Serial Bus) interface 10, and a main body operation keypad 11.

The tuner 1 tunes and demodulates (for example, by OFDM (Orthogonal Frequency Division Multiplexing) demodulation) TV broadcasting signals received from an antenna 102. The video/audio processing portion 2 sends, to the output portion 4, video/audio signals received form the tuner 1, video/audio signals reproduced by the HDD recording/reproducing portion 5 or the DVD recording/reproducing portion 6, and video/audio signals received from the USB interface 10, or sends video/audio signals received from the tuner 1 or the USB interface 10 to the HDD recording/reproducing portion 5 or the DVD recording/reproducing portion 6. The OSD portion 3 sends, to the output portion 4, OSD image data generated based on an instruction by the control portion 7. The output portion 4 externally outputs combined video signals combined of video signals received from the video/audio processing portion 2 and OSD image data received from the OSD portion 3, externally outputs video signals received from the video/audio processing portion 2 as they are without the combining process, externally outputs OSD image data received from the OSD portion 3 as they are without the combining process, or externally outputs audio signals received from the video/audio processing portion 2. Output signals from the output portion 4 are sent to a TV receiver (not shown) connected to the HDD-incorporated DVD recorder 100. The TV receiver connected to the HDD-incorporated DVD recorder 100 performs video display and audio output based on the output signals from the output portion 4.

The HDD recording/reproducing portion 5 records video/audio signals received from the video/audio processing portion 2 onto the hard disk or reproduces video/audio signals recorded on the hard disk. The DVD recording/reproducing portion 6 records video/audio signals received from the video/audio processing portion 2 onto a DVD or reproduces video/audio signals recorded on a DVD. Note that a DVD is removably mounted to the DVD recording/reproducing portion 6.

The light receiving portion 9 receives remote controller infrared signals transmitted from the remote controller transmitter 101, converts them into electric signals, extracts operation codes from the electric signals, and outputs them to the control portion 7. The control portion 7 controls each part of the HDD-incorporated DVD recorder 100 based on control programs and various settings (for example, those in a data table designating the relationship between individual operation codes and functions) stored in the non-volatile memory 8, based on operation codes received from the light receiving portion 9, and based on operation codes defined by signals outputted from the main body operation keypad 11 having a plurality of main body keys. Description is made later for the operation of the HDD-incorporated DVD recorder 100 when a USB memory 103 is connected to the USB interface 10.

The remote controller transmitter 101 includes a light emitting portion 12, a control portion 13, a remote controller operation keypad 14 having a plurality of remote controller keys, and a non-volatile memory 15. The number of remote controller keys on the remote controller operation keypad 14 is more than that of main body keys on the main body operation keypad 11.

The remote controller operation keypad 14 sends, to the control portion 13, instruction signals according to key operation by the user. The control portion 13 looks up the data table stored in the non-volatile memory 15 to send, to the light emitting portion 12, an operation code corresponding to an instruction signal received from the remote controller operation keypad 14. The data table stored in the non-volatile memory 15 designates the relationship between individual instruction signals outputted from the remote controller operation keypad 14 and individual operation codes. The light emitting portion 12 superimposes on a carrier signal the operation code received from the control portion 13 and converts the carrier signal (electric signal) superimposed with the operation code into a remote controller infrared signal (light signal) to output.

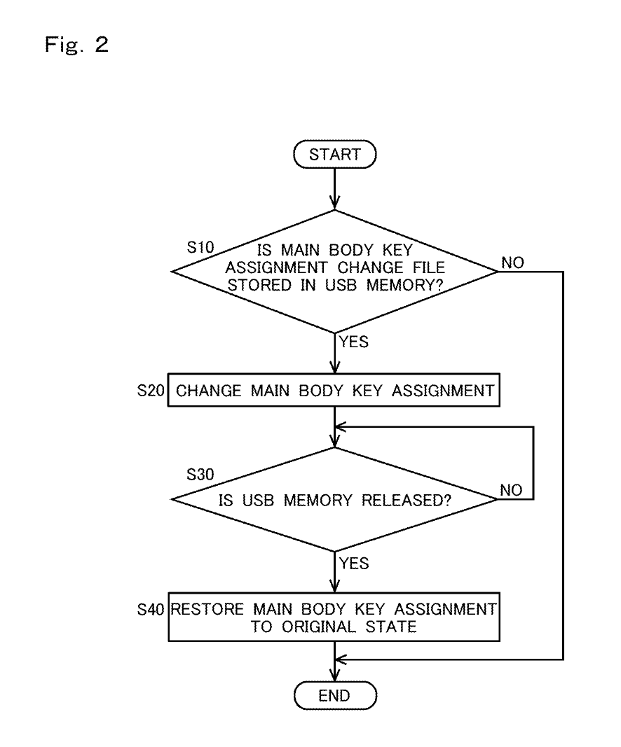

Next explained is the operation of the HDD-incorporated DVD recorder 100 when the USB memory 103 is connected to the USB interface 10, with reference to the flowchart in FIG. 2.

When the control portion 7 has recognized connection of a USB memory 103 to the USB interface 10, the flowchart operation in FIG. 2 will start.

In the step S10, the control portion 7 determines via the USB interface 10 whether a main body key assignment change file is stored in the USB memory 103.

The main body key assignment change file can be stored in the USB memory 103, for example, in a manner in which the manufacturer of the HDD-incorporated DVD recorder 100 publicly posts a main body key assignment change file on the home page of the manufacturer and lets users download and store in the USB memory 103 the main body key assignment change file using, for example, personal computers connectable to the Internet.

If no main body key assignment change file is stored in the USB memory 103 (case “NO” in the step S10), the flow operation immediately ends.

If a main body key assignment change file is stored in the USB memory 103 (case “YES” in the step S10), the control portion 7 changes the main body key assignment based on the content of the main body key assignment change file (step S20).

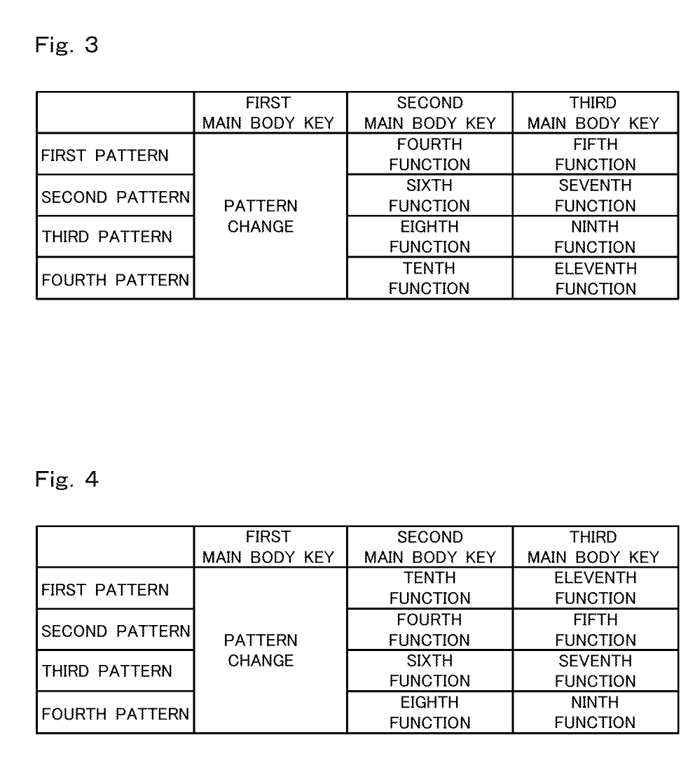

Here, an explanation of an example of main body key assignment change is made with reference to FIG. 3 using an example in which the main body operation keypad 11 has three main body keys (a first, a second and a third main body keys).

Before connection of the USB memory 103 storing a main body key assignment change file to the USB interface 10, the first main body key is assigned with a first function, the second main body key is assigned with a second function, and the third main body key is assigned with a third function.

When the USB memory 103 storing a main body key assignment change file is connected to the USB interface 10, the functions assigned to the first main body key, the second main body key and the third main body key will be changed to the content designated by FIG. 3. Specifically, immediately after the USB memory 103 storing a main body key assignment change file is connected to the USB interface 10, the second main body key will be assigned with a fourth function and the third main body key will be assigned with a fifth function. Then, when the first main body key is pressed once, the second main body key will be assigned with a sixth function and the third main body key will be assigned with a seventh function, and when the first main body key is pressed twice, the second main body key will be assigned with a eighth function and the third main body key will be assigned with a ninth function, and when the first main body key is pressed three times, the second main body key will be assigned with a tenth function and the third main body key will be assigned with a eleventh function. Note that the third to eleventh functions are those originally assigned to remote controller keys on the remote controller operation keypad 14.

If the main body key assignment change is that designated by FIG. 3, it will be inconvenient for users who frequently use the tenth or eleventh function. It is, therefore, preferable that the content of the main body key assignment change be customized by users themselves. Users, for example, who frequently use the tenth or eleventh function can customize and change the main body key assignment to that designated by FIG. 4. Besides a customization by order switching such as switching from the content designated by FIG. 3 to that by FIG. 4, a customization may be considered in which some patterns are deleted or new patterns are added. Customization may be made, for example, in a manner where the main body key assignment change file publicly posted in the home page of the manufacturer of the HDD-incorporated DVD recorder 100 is arranged such that it can be customized by users during their accesses to the home page so that they can download the customized main body key assignment change file, or in a manner where a customizing tool file is publicly posted as well as a main body key assignment change file in the home page of the manufacturer of the HDD-incorporated DVD recorder 100 so that users can download the customizing tool file with the main body key assignment change file using, for example, personal computers connectable to the Internet and can customize the main body key assignment change file using the customizing tool file on, for example, personal computers.

Coming back to FIG. 2, explanation is continued for the operation of the HDD-incorporated DVD recorder 100 when a USB memory 103 is connected to the USB interface 10.

After the main body key assignment has been changed, i.e., the step S20 has been processed, the control portion 7 monitors whether the connection between the USB interface 10 and the USB memory 103 is released (step S30). If the connection between the USB interface 10 and the USB memory 103 has been released (case “YES” in the step S30), the control portion 7 will restore the main body key assignment to the original state before execution of the step S20 process (step S40) and terminate the flow operation.

With the above operation, functions that can be executed by the operation of remote controller keys can be executed by the operation of main body keys using a main body key assignment change file stored in a USB memory 103. Because it uses a main body key assignment change file stored in a USB memory 103, it does not waste the memory capacity of the HDD-incorporated DVD recorder 100. Customization of the main body key assignment change file is easy because the main body key assignment change file is stored in a USB memory 103 outside the HDD-incorporated DVD recorder 100 instead of being stored in a memory in the HDD-incorporated DVD recorder 100.

### Second Embodiment of the Present Invention

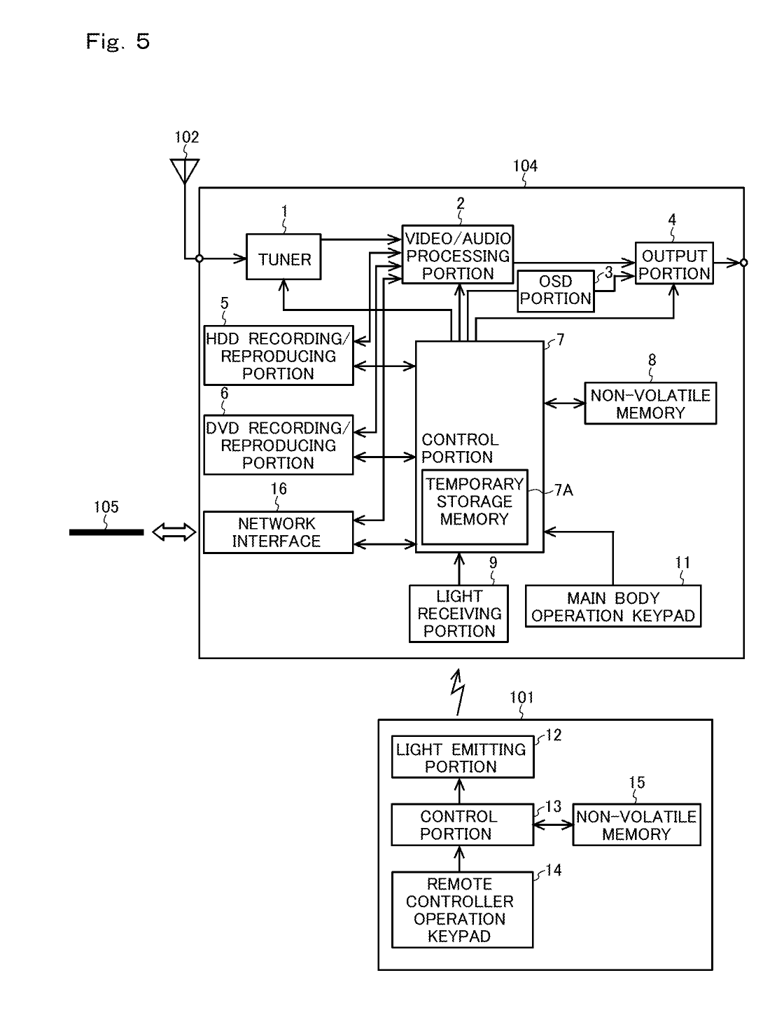

FIG. 5 shows a schematic configuration of a HDD-incorporated DVD recorder according to a second embodiment of the present invention. In FIG. 5, the same parts as in FIG. 1 are assigned with the same reference numbers and detailed explanation will be omitted. The HDD-incorporated DVD recorder 104 according to the second embodiment of the present invention in FIG. 5 (referred to as “HDD-incorporated DVD recorder 104,” hereafter) has a configuration, in which the USB interface 10 is removed and a network interface 16 is newly added from/to the HDD-incorporated DVD recorder 100, having an Internet connection function. Concrete control in the control portion 7 may be partially different from that of the first embodiment. The network interface 16 is connected with network cable 105 for Internet connection.

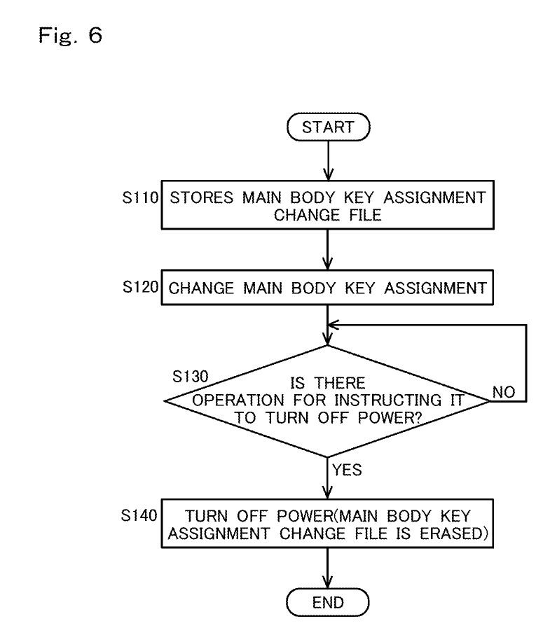

On the HDD-incorporated DVD recorder 104, when a predetermined main body key is kept pressed, the flowchart in FIG. 6 will start.

When a predetermined main body key is kept pressed, the control portion 7 automatically accesses the home page of the manufacturer of the HDD-incorporated DVD recorder 104 via the network interface 16, and downloads a main body key assignment change file publicly posted in the home page and stores it in the temporary storage memory 7A in the control portion 7 (step S110).

In the step S120 following the step S110, the control portion 7 changes the main body key assignment based on the content of the main body key assignment change file.

Since the examples of main body key assignment change and customization are the same as those in the above-mentioned first embodiment, their explanation is omitted here. Customization may be made, for example, in a manner where the main body key assignment change file publicly posted in the home page of the manufacturer of the HDD-incorporated DVD recorder 104 is arranged such that it can be customized by users during their accesses to the home page so that they can download the customized main body key assignment change file. In this case, since customization is performed using a main body key, the operability during customization is inferior to that of the above-mentioned first embodiment.

After processing the step S120, the control portion 7 determines whether an operation has been made for instructing the HDD-incorporated DVD recorder 104 to turn off the power (step S130). For example, when a user presses, during the power on state, the power button (not shown) provided separately from the main body operation keypad 11, it can be determined that an operation has been made for instructing the HDD-incorporated DVD recorder 104 to turn of the power.

When an operation has been made for instructing the HDD-incorporated DVD recorder 104 to turn off the power (case “YES” in the step S130), the control portion 7 executes the process to turn off the power (step S140) and terminates the flow operation. Tuning off the power will erase the main body key assignment change file stored in the temporary storage memory (volatile memory) 7A in the control portion 7. Therefore, when the power is turned on the next time, the main body key assignment will be restored to the original state before execution of the step S120 process.

With the above operation, functions that can be executed by the operation of remote controller keys can be executed by the operation of main body keys using a main body key assignment change file downloaded via the Internet. Because the main body key assignment change file downloaded via the Internet is stored only temporarily, it does not waste the memory capacity of the HDD-incorporated DVD recorder 104.

### Third Embodiment of the Present Invention

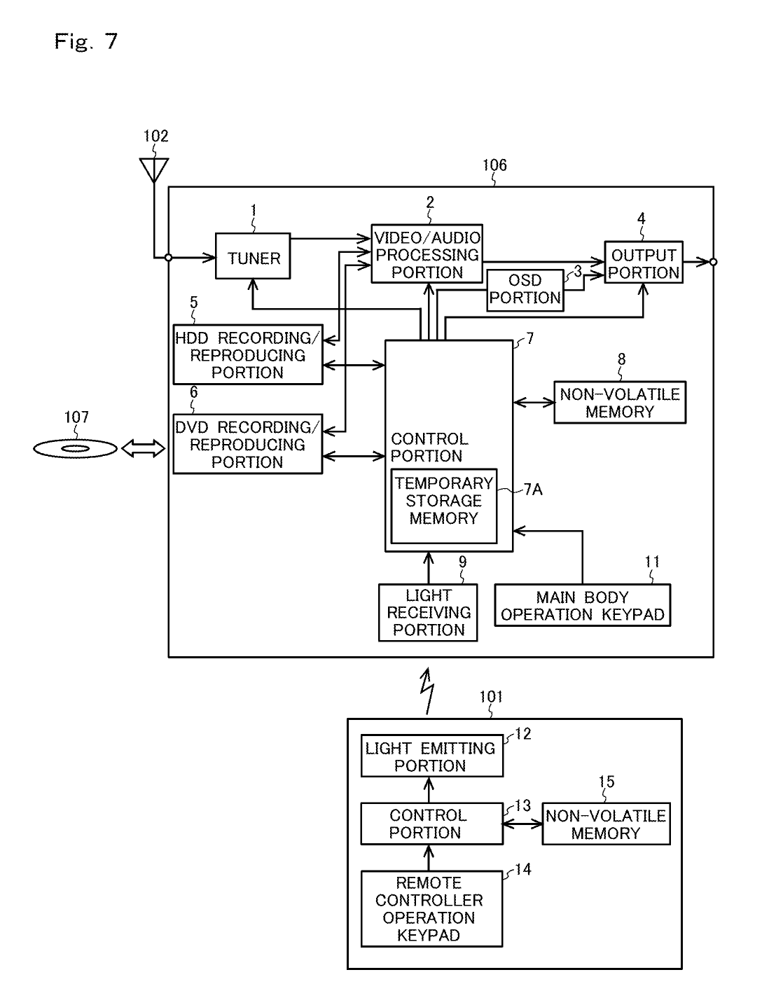

FIG. 7 shows a schematic configuration of a HDD-incorporated DVD recorder according to the third embodiment of the present invention. In FIG. 7, the same parts as in FIGS. 1 and 5 are assigned with the same reference numbers and detailed explanation will be omitted. The HDD-incorporated DVD recorder 106 according to the third embodiment of the present invention in FIG. 7 (referred to as “HDD-incorporated DVD recorder 106,” hereafter) has a configuration in which the network interface 16 is removed from the HDD-incorporated DVD recorder 104. Concrete control in the control portion 7 may be partially different from that of the first and second embodiments.

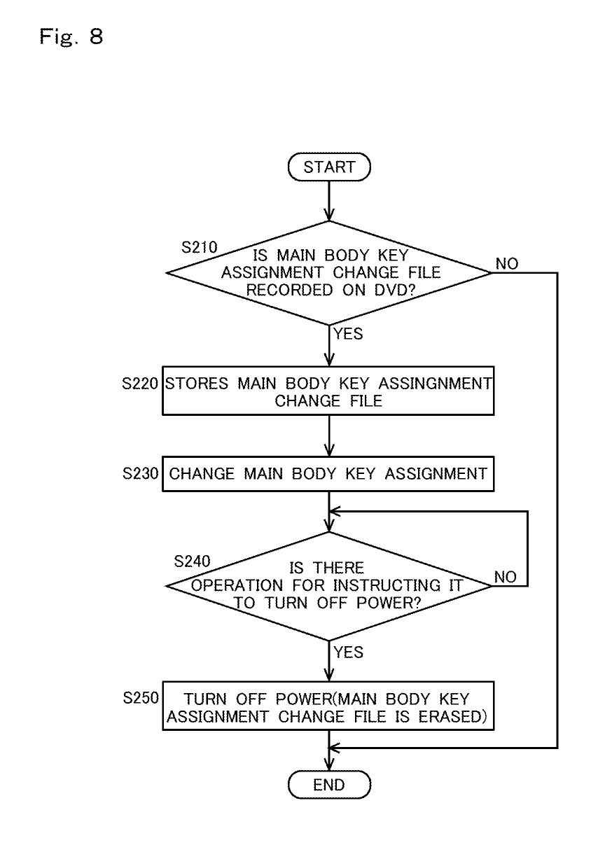

Next explained is the operation of the HDD-incorporated DVD recorder 106 when a DVD 107 is mounted into the DVD recording/reproducing portion 6, with reference to the flowchart in FIG. 8.

When the control portion 7 has recognized that a DVD 107 has been mounted into the DVD recording/reproducing portion 6, the flowchart in FIG. 8 will start.

In the step S210, the control portion 7 determines via DVD recording/reproducing portion 6 whether a main body key assignment change file is recorded on the DVD 107.

The main body key assignment change file can be recorded on the DVD 107, for example, in a manner in which the manufacturer of the HDD-incorporated DVD recorder 106 publicly posts a main body key assignment change file on the home page of the manufacturer and let users download and store on the DVD 107 the main body key assignment change file using, for example, personal computers connectable to the Internet. The manufacturer of the HDD-incorporated DVD recorder 106 may distribute a main body key assignment change file recorded on a DVD 107.

If no main body key assignment change file is recorded on the DVD 107 (case “NO” in the step S210), the flow operation immediately ends.

If a main body key assignment change file is recorded on the DVD 107 (case “YES” in the step S210), the control portion 7 stores, in the temporary storage memory 7A in the control portion 7, the main body key assignment change file read by the DVD recording/reproducing portion 6 (step S220).

In the step S230 following the step S220, the control portion 7 changes the main body key assignment based on the content of the main body key assignment change file stored in the temporary storage memory 7A.

Since the examples of main body key assignment change and customization are the same as those in the above-mentioned first embodiment, explanation is omitted here.

After processing the step S230, the control portion 7 determines whether an operation has been made for instructing the HDD-incorporated DVD recorder 106 to turn off the power (step S240). For example, when a user has pressed, during the power on state, the power button (not shown) provided separately from the main body operation keypad 11, it can be determined that an operation has been made for instructing the HDD-incorporated DVD recorder 106 to turn of the power.

When an operation has been made for instructing the HDD-incorporated DVD recorder 106 to turn off the power (case “YES” in the step S240), the control portion 7 executes the process to turn off the power (step S250) and terminates the flow operation. Tuning off the power will erase the main body key assignment change file stored in the temporary storage memory (volatile memory) 7A in the control portion 7. Therefore, when the power is turned on the next time, the main body key assignment will be restored to the original state before execution of the step S230 process.

With the above operation, the main body key assignment change file recorded on the DVD 107 is temporarily stored into a memory in the HDD-incorporated DVD recorder 106. The main body key assignment change file temporarily stored is used so that functions that can be executed by the operation of remote controller keys can be executed by the operation of main body keys. Because the main body key assignment change file is stored only temporarily, it does not waste the memory capacity of the HDD-incorporated DVD recorder 106. Customization of the main body key assignment change file is easy because the main body key assignment change file is stored on a DVD 107 outside the HDD-incorporated DVD recorder 106 instead of being stored in a memory in the HDD-incorporated DVD recorder 106. Because the main body key assignment change file recorded on the DVD 107 is temporarily stored in a memory in the HDD-incorporated DVD recorder 106, the main body key assignment change file can be used after the DVD 107 is replaced with another DVD.

### Modification Example

Embodiments according to the present invention have been described, but it should be understood that the scope of the present invention is not limited to these embodiments, and that various variations and modifications can be applied within the range not deviating from the spirit and the scope of the present invention.

For example, the above-mentioned first embodiment, where a USB memory is used as an external recording medium, may use another external recording medium (for example, SD card) other than a USB memory. In this case, the present invention may be applied by installing an external recording medium interface (for example, SD card interface) other than that for the USB memory, instead of or in addition to the USB interface 10.

In the above-mentioned second embodiment, for example, when a predetermined main body key is kept pressed, the control portion 7 automatically accesses the home page of the manufacturer of the HDD-incorporated DVD recorder 104 via the network interface 16 and downloads a main body key assignment change file publicly posted in the home page. Alternatively, instead of or in addition to this, an external recording medium interface (for example, USB interface) may be installed and when an external recording medium is connected to the external recording medium interface, the control portion 7 may automatically access the home page of the manufacturer of the HDD-incorporated DVD recorder 104 via the network interface 16 and download a main body key assignment change file publicly posted in the home page.

For example, in case of the above-mentioned second and third embodiments, the main body key assignment change file is stored in the temporary storage memory 7A. Instead, the main body key assignment change file may be stored in a non-volatile memory 8. In this case, temporary storage of the main body key assignment change file may be achieved by purposely discarding the main body key assignment change file stored in the non-volatile memory 8 before executing the power off process.

It is noted that the present invention may be applied to audiovisual apparatuses (e.g., TV receivers, etc.) other than HDD-incorporated DVD recorders, audio apparatuses (e.g., CD players, etc.) and visual apparatuses (e.g., projectors, etc.) and further to electric apparatuses having remote controller receiver functions in general.

What is claimed is:

1. An electric apparatus having a remote controller receiver function, comprising:
a main body operation keypad comprising a plurality of main body keys; and
a control portion for changing functions assigned to the main body keys based on a specific file provided from outside.

2. The electric apparatus as claimed in claim 1, wherein
the electric apparatus comprises an external recording medium interface to removably connect an external recording medium, and the specific file is provided from the external recording medium.

3. The electric apparatus as claimed in claim 2, wherein
the control portion changes functions assigned to the main body keys based on the specific file only during a period when an external recording medium recording the specific file is connected to the external recording medium interface.

4. The electric apparatus as claimed in claim 1, wherein
the electric apparatus comprises a network interface to be connected to a network, and
the specific file is provided via the network and the network interface.

5. The electric apparatus as claimed in claim 4, wherein
the electric apparatus comprises a memory portion to temporarily store the specific file, and
the control portion changes functions assigned to the main body keys based on the specific file temporarily stored in the memory portion.

6. The electric apparatus as claimed in claim 1, wherein
the electric apparatus is an optical disk device, and
the specific file is provided from an optical disk.

7. The electric apparatus as claimed in claim 6, wherein
the electric apparatus comprises a memory portion to temporarily store the specific file, and
the control portion changes functions assigned to the main body keys based on the specific file temporarily stored in the memory portion.
